(19) United States
(12) Patent Application Publication
(10) Pub. No.: US 2007/0103828 A1
(43) Pub. Date: May 10, 2007

(54) Methods and systems for detecting a protection device operation

(75) Inventors: Kip M. Larson, Rapid City, SD (US); Dee R. Walker, Rapid City, SD (US)

Correspondence Address: MERCHANT & GOULD PC, P.O. BOX 2903, MINNEAPOLIS, MN, 55402-0903, US

(73) Assignee: SymCom, Inc., Wilmington, DE (US)

(21) Appl. No.: 11/268,830

(22) Filed: Nov. 8, 2005

(51) Int. Cl. H02H 3/24

(52) U.S. Cl. 361/88

(57) ABSTRACT

Systems and methods are disclosed for detecting a protection device operation. The disclosed systems and methods may include detecting a voltage across a protection device. The voltage may be produced when the protection device operates from a closed state to an opened state. Furthermore, the disclosed systems and methods may include latching, in response to the detected voltage, the indication that the protection device operated from the closed state to the opened state. Moreover, the disclosed systems and methods may include transmitting, in response to the detected voltage, an indication that the protection device operated from a closed state to an opened state.

### BACKGROUND

I. Field of the Invention

The present invention generally relates to methods and systems for detecting a protection device operation. More particularly, the present invention relates to detecting a protection device operation, for example, even when a voltage from a supply system is removed after the protection device operates.

II. Background Information

Protection devices such as fuses and circuit breakers are applied in many electrical systems that are used by people on an everyday basis. For example, protection devices are part of electrical systems found in buildings, automobiles, boats, motorcycles, and other vehicles. For example, when protection devices operate, current flow to a particular load is interrupted creating an open circuit due to an overcurrent condition. In order to reinstate the current flow and bring the load back in service, the protection device must be located and replaced or reset.

In many cases, a system's protection devices are grouped together in a box. The box may or may not be located in an easily accessible place. Additionally, the box may be packed with numerous protection devices positioned side-by-side making it difficult to determine which device has operated. In order to locate an operated protection device, for example, each fuse in the box must be replaced, each breaker must be reset, or electrical test equipment must be used to locate the protection device that operated. Moreover, the difficulties inherent in troubleshooting are even more pronounced when a blown fuse, for example, is replaced in the dark or without adequate physical working area.

While conventional systems may provide indicators for identifying tripped circuit breakers or fuses, these devices are not suitable for high voltage circuits above a few tens of volts, for example. In addition, conventional systems may not support both alternating current (AC) and direct current (DC) power systems, or may require connection to other conductors such as neutral or ground conductors for proper operation. Additionally many power supply systems support additional control systems, such as motor controllers, that will open quickly after an overcurrent event. Accordingly, the voltage across a protection device may be removed after the protection device operates. This voltage removal will extinguish indicators on conventional systems, which require continuous potential across a device for indication. Furthermore, having only local indication may require a service technician to locate an operated device's location before correcting the problem.

In view of the foregoing, there is a need for methods and systems for detecting a protection device operation more optimally. Furthermore, there is a need for detecting a protection device operation, for example, even when a voltage from a power supply system is removed after the protection device operates.

### SUMMARY

Consistent with embodiments of the present invention, systems and methods are disclosed for detecting a protection device operation.

In accordance with one embodiment, a method for detecting a protection device operation comprises detecting a voltage across a protection device, the voltage produced when the protection device operates from a closed state to an opened state and transmitting, in response to the detected voltage, an indication that the protection device operated from a closed state to an opened state.

According to another embodiment, a system for detecting a protection device operation comprises a first component configured to detect a voltage across a protection device, the voltage produced when the protection device operates from a closed state to an opened state and a transmitting component configured for transmitting, in response to the detected voltage, an indication that the protection device operated from a closed state to an opened state.

In accordance with yet another embodiment, a system for detecting a protection device operation comprises a memory storage for maintaining a database and a processing unit coupled to the memory storage, wherein the processing unit is operative to detect a voltage across a protection device, the voltage produced when the protection device operates from a closed state to an opened state and transmit, in response to the detected voltage, an indication that the protection device operated from a closed state to an opened state.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary energy delivery system including a detector system consistent with an embodiment of the present invention;

FIG. 2 is a block diagram of an exemplary detector system consistent with an embodiment of the present invention;

FIG. 3 is a block diagram of an exemplary detector system consistent with another embodiment of the present invention; and

FIG. 4 is a flow chart of an exemplary method for detecting a protection device operation consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention detect a protection device operation. Consistent with an embodiment of the invention, a detector system may indicate a protection device's status with, for example, visual or remote light emitting diodes (LEDs) and/or remote electrical indication. The detector system may be connected across a protection device in conjunction with an AC or DC power system. Immediately after the protection device operates to clear, for example, a high current fault, a momentary or continuous voltage across the protection device may be generated by a power system feeding the protection device. This voltage may be detected as an indication that the protection device operated (e.g. a circuit breaker tripped or a fuse blew.) Moreover, the indication may stay “latched” even when power to the protection device is removed. Furthermore, the detector system may electrically isolate a signal providing the indication from the power system. In addition the detector system may remotely provide the indication including data identifying the operated protection device.

An embodiment consistent with the invention may comprise a system for detecting a protection device operation. The system may comprise a first component configured to detect a voltage across a protection device. The voltage may be produced when the protection device operates from a closed state to an opened state. In addition, the system may comprise a transmitting component configured for transmitting, in response to the detected voltage, an indication that the protection device operated from a closed state to an opened state.

Another embodiment consistent with the invention may comprise a system for detecting a protection device operation. The system may comprise a memory storage for maintaining a database and a processing unit coupled to the memory storage. The processing unit may be operative to detect a voltage across a protection device. The voltage may be produced when the protection device operates from a closed state to an opened state. In addition, the processing unit may be operative to transmit, in response to the detected voltage, an indication that the protection device operated from a closed state to an opened state.

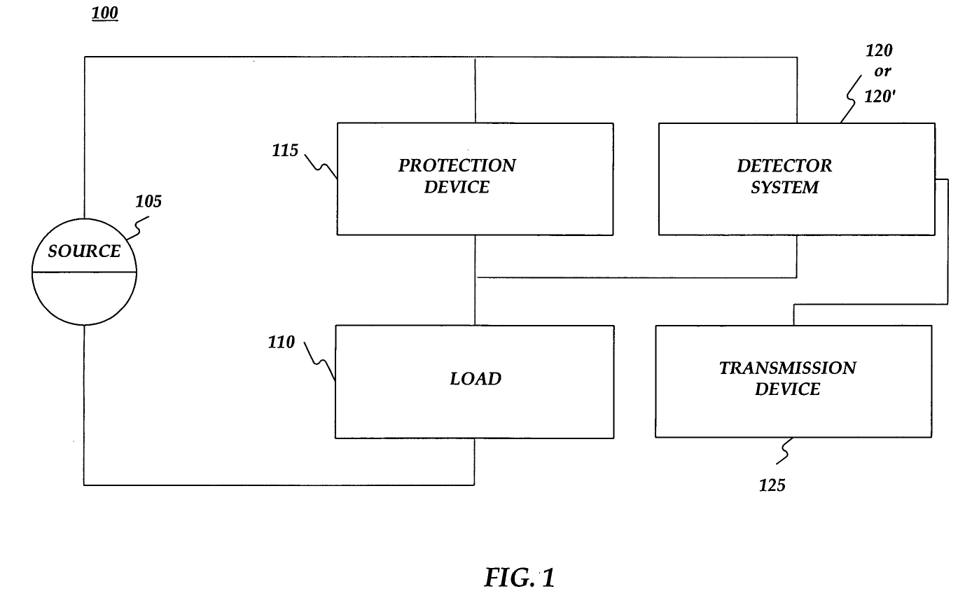

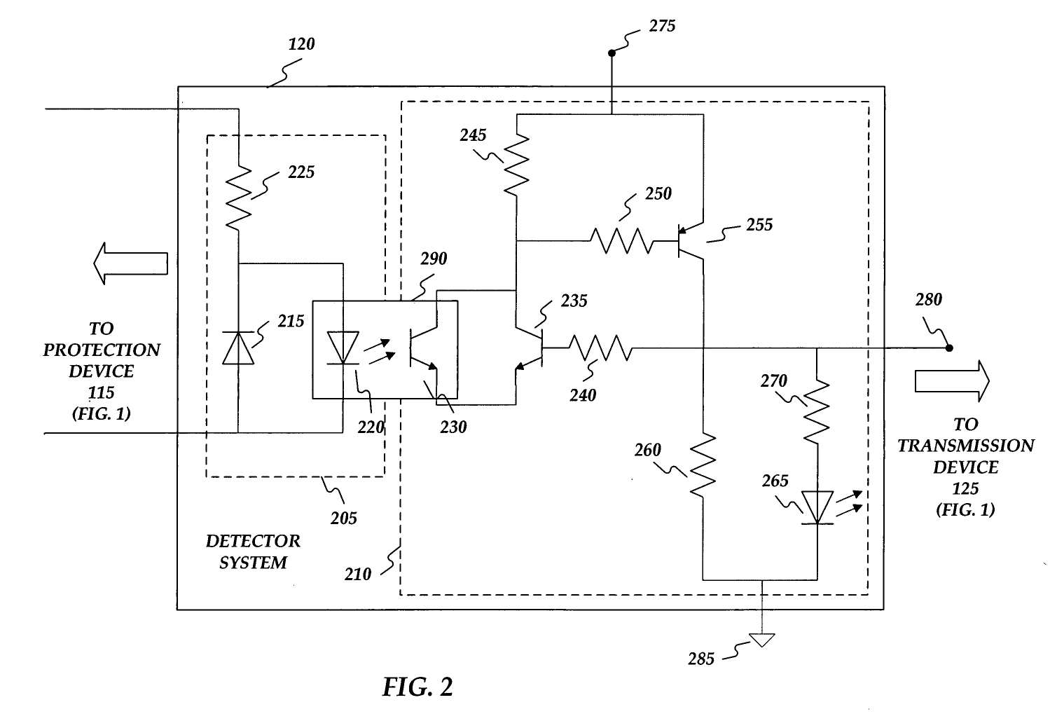

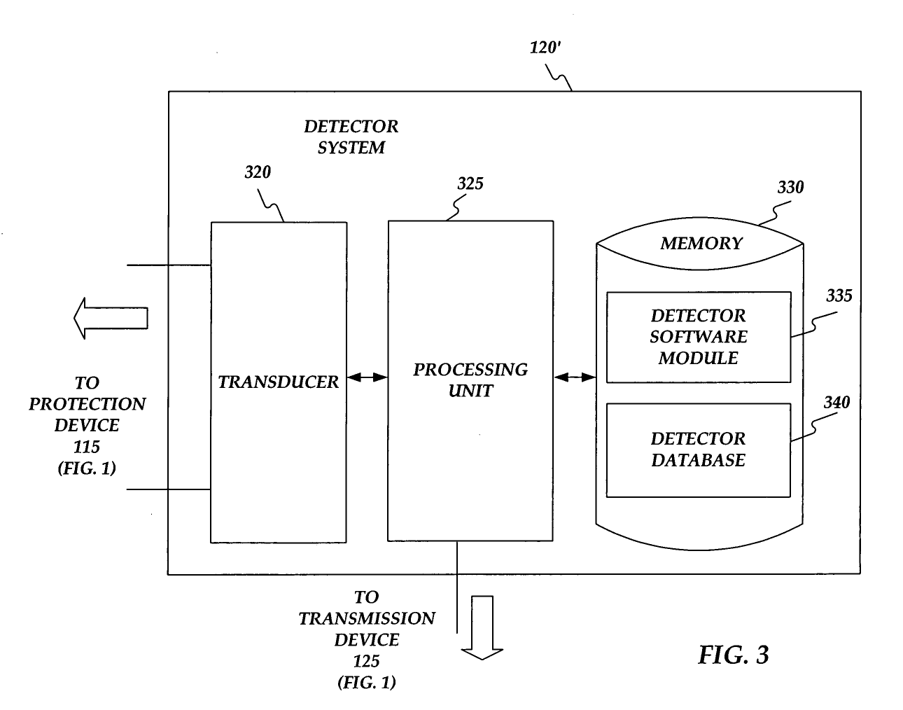

Consistent with an embodiment of the present invention, the aforementioned memory, processing unit, and components may be implemented in a detector system, such as an exemplary detector system 120 or 120′ used in conjunction with a power supply system 100 of FIG. 1. Any suitable combination of discrete electrical components, hardware, software, and/or firmware may be used to implement the memory, processing unit, or components. By way of example, the memory, processing unit, or components may be implemented with any of detector system 120 (FIG. 2) or 120′ (FIG. 3), in combination with system 100. The aforementioned system and processor are exemplary and other systems and processors may comprise the aforementioned memory, processing unit, or components, consistent with embodiments of the present invention.

By way of a non-limiting example, FIG. 1 illustrates system 100 in which the features and principles of the present invention may be implemented. As illustrated in the block diagram of FIG. 1, system 100 may include a source 105, a load 110, a protection device 115, detector system 120 or 120′, and transmission device 125. Source 105 may comprise an electric energy source to include a DC source or an AC source. The aforementioned are exemplary and source 105 may comprise other source types. Load 110 may comprise any type element configured to or capable of consume electric energy in, for example, any combination of a resistive, capacitive, or reactive manner.

Protection device 115 may be configured to protect load 110. For example, protection device 115 may be configured to operate from a closed position to an opened position after a predetermined current level passing through load 110 is detected for a predetermined time period. For example, protection device 115 may comprise an overcurrent protection device such as a fuse or a circuit breaker. The aforementioned are exemplary and protection device 115 may comprise other types of protection devices. Detector system 120 or 120′ may comprise any device capable of detecting a voltage across protection device 115 produced when protection device 115 operates from a closed state to an opened state. Accordingly, detector system 120 or 120′ may not require connection to other conductors such as neutral or ground conductors for proper operation. Detector system 120 and 120′ are described, for example, in greater detail below with respect to FIG. 2 and FIG. 3.

Transmission device 125 may comprise any device capable of transmitting, in response to the detected voltage received from detector system 120 or 120′, an indication that the protection device operated from a closed state to an opened state. Moreover, transmission device 125 may also include, in the transmitted indication, data identifying protection device 115. For example, protection device 115 may identify itself to detector system 120 or 120′, which may in turn pass this identification to transmission device 125. In addition, detector system may contain information identifying protection device 115 to which it is connected. Transmission device 125 may transmit or otherwise communicate over a network as described below. Moreover, transmission device 125 may transmit or otherwise communicate over radio transmission via the airwaves. For example, transmission device 125 may use wireless transmission, including infrared line of sight, cellular, microwave, satellite, packet radio, and spread spectrum radio. The aforementioned are exemplary and other wireless or wire line techniques may be used. Any suitable combination of discrete electrical components, hardware, software, and/or firmware may be used to implement transmission device 125.

By way of a non-limiting example, FIG. 2 illustrates detector system 120 in which the features and principles of the present invention may be implemented. As illustrated in the block diagram of FIG. 2, detector system 120, connected across protection device 115, may include a first component 205 (e.g. a first circuit or detector circuit) optically coupled to a second component 210 (e.g. a second circuit or latching circuit) through optical isolator 290. During normal operating conditions, protection device 115 may represent a low impedance (e.g. near zero ohms) as seen by detector system 120. Accordingly, detector system 120 sees an electrical potential of nearly zero volts across protection device 115. In the event that protection device 115 operates, however, a momentary or continuous voltage may be produced across protection device 115. This voltage may be equal to a voltage applied to system 100 via source 105. Consequently, when the voltage is produced across protection device 115 when protection device 115 operates, current may conduct through a first resistor 225 and an opto-isolator LED 220. A diode 215 may prevent large reverse voltages from damaging LED 220.

As stated above, a momentary or continuous voltage may be produced across protection device 115 when protection device 115 operates from closed to open. This voltage may be continuous if load 110 stays connected to source 105 after protection device 115 operates from closed to open. In many cases, however, system 100 may include other equipment (not shown) that detects a voltage loss due to protection device 115's operation. This other equipment may isolate load 110 from all conductors connected to source 105. In this case, where load 110 may become isolated, a momentary voltage (and not a continuous) may be produced across protection device 115 when protection device 115 operates from closed to open. For example, the momentary voltage may be a voltage of limited duration. When load 110 comprises a motor, for example, the other equipment may comprise a motor contactor. For example, the time for the other equipment to isolate load 110 from system 100 may take from 30 milliseconds to 150 milliseconds. According to this example, the momentary voltage that may be produced across protection device 115 when protection device 115 operates from closed to open may last from 30 milliseconds to 150 milliseconds.

The resulting photo current in a first transistor 230 of optical isolator 290 enables a second transistor 255 to turn on that may latch a third transistor 235 in an “on” state. The result is that an output signal 280 may be held at an auxiliary power supply voltage (e.g. supplied between a node 275 and a signal ground 285.) The second transistor 255 may latch the third transistor 235 in an “on” state even when the aforementioned momentary voltage is produced across protection device 115 when protection device 115 operates from closed to open. For example, the diodes 220's “half rectifier” configuration may latch the third transistor 235 in the “on” state when the momentary voltage is present for greater than approximately 16 milliseconds. If a “full rectifier” configuration (not shown) is used, for example, the third transistor 235 may latch in the “on” state when the momentary voltage is present for greater than approximately 8 milliseconds.

If a first LED 265 or other indicating device exists, it may energize and hold its state until the auxiliary power supply voltage is removed from second component 210. The auxiliary power supply voltage may be supplied from an external DC supply, batteries, or other source to allow output signal 280 and first LED 265 to remain on, even when source 105 is removed.

Detector system 120 allows protection devices from many different power systems (even at high voltages) to be safely isolated from a system configured to sense output signal 280. In other words, detector system 120 may electrically isolate output signal 280 from source 105. Resistors 240, 245, 250, 260, and 270 may be selected to provide a predetermined performance level to detector system 120.

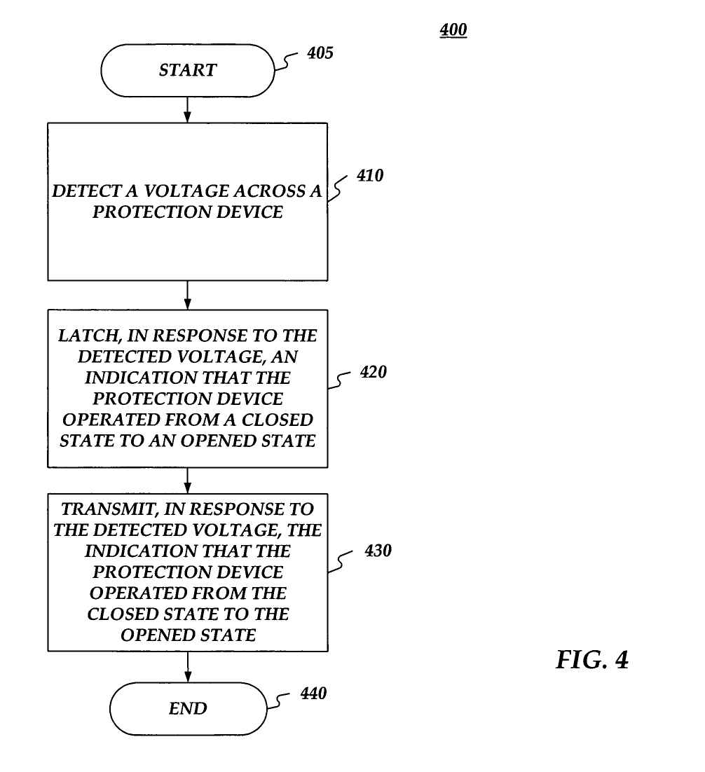

FIG. 3 shows detector system 120′ of FIG. 1 in more detail. As shown in FIG. 3, detector system 120′ may include a transducer 320, a processing unit 325 and a memory 330. Transducer 320 may receive a detected voltage across protection device 115, the voltage produced when protection device 115 operates from a closed state to an opened state. Transducer 320 may electrically isolate protection device 115 from processing unit 325 using, for example, an optical isolator. Memory 330 may include a detector software module 335 and a detector database 340. While executing on processing unit 325, detector software module 335 may perform processes for detecting a protection device operation, including, for example, one or more of the stages of method 400 described below with respect to FIG. 4.

Detector system 120′ (“the processor”) included in system 100 may be implemented using a personal computer, network computer, mainframe, or other similar microcomputer-based workstation. The processor may though comprise any type of computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, any of the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Detector system 120′ may communicate with other devices via a network (not shown.) The network may comprise, for example, a local area network (LAN) or a wide area network (WAN). Such networking environments are commonplace in offices, enterprise-wide computer networks, intranets, and the Internet. When a LAN is used as the network, a network interface located at any of the processor may be used to interconnect any of the processor. When the network is implemented in a WAN networking environment, such as the Internet, the processor may typically include an internal or external modem (not shown) or other means for establishing communications over the WAN. Further, in utilizing the network, data sent over the network may be encrypted to insure data security by using known encryption/decryption techniques.

In addition to utilizing a wire line communications system as the network, a wireless communications system, or a combination of wire line and wireless may be utilized as the network in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processor in the wireless environment can be any mobile terminal, such as the mobile terminals described above. Wireless data may include, but is not limited to, paging, text messaging, e-mail, Internet access and other specialized data applications specifically excluding or including voice transmission. For example, the processor may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

System 100 may also transmit data by methods and processes other than, or in combination with, the network. These methods and processes may include, but are not limited to, transferring data via, diskette, flash memory sticks, CD ROM, facsimile, conventional mail, an interactive voice response system (IVR), or via voice over a publicly switched telephone network.

FIG. 4 is a flow chart setting forth the general stages involved in an exemplary method 400 consistent with the invention for detecting a protection device operation using system 100 of FIG. 1. Exemplary ways to implement the stages of exemplary method 400 will be described in greater detail below. While exemplary method 400 is described in terms of detector system 120, detector system 120′ or any suitable combination of discrete electrical components, hardware, software, and/or firmware may be used. Exemplary method 400 may begin at starting block 405 and proceed to stage 410 where detector system 120 may detect a voltage across protection device 115. The voltage may be produced when protection device 115 operates from a closed state to an opened state. For example, protection device 115 may operate from the closed state to the opened state due to an overcurrent condition present through load 110.

From stage 410, where detector system 120 detects the voltage across protection device 115, exemplary method 400 may advance to stage 420 where detector system 120 may latch, in response to the detected voltage, an indication that protection device 115 operated from the closed state to the opened state. For example, as stated above, a momentary or continuous voltage may be produced across protection device 115 when protection device 115 operates from closed to open. This voltage may be continuous if load 110 stays connected to ground after protection device 115 operates from closed to open. In many cases, however, system 100 may include other equipment (not shown) that detects a voltage loss due to protection device 115's operation. This other equipment may isolate load 110 from system 100 including isolating load 110 from source 105. In this case where load 110 may become isolated, a momentary voltage (and not a continuous) may be produced across protection device 115 when protection device 115 operates from closed to open. When load 110 comprises a motor, the other equipment may comprise a motor contactor. The time for the other equipment to isolate load 110 from system 100 may take from 30 milliseconds to 150 milliseconds. According to this example, the momentary voltage that may be produced across protection device 115 when protection device 115 operates from closed to open may last from 30 milliseconds to 150 milliseconds.

Once detector system 120 latches in stage 420, exemplary method 400 may continue to stage 430 where detector system 120 may transmit, in response to the detected voltage, the indication that the protection device operated from the closed state to the opened state. For example, the indication may comprise a visible light emitting diode (LED) signal, an infrared light emitting diode (LED) signal, an audible signal, or an electrical signal. Furthermore, the indication may comprise data identifying the protection device. After detector system 120 transmits the indication in stage 430, exemplary method 400 may then end at stage 440.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for detecting a protection device operation, the method comprising:
detecting a voltage across a protection device, the voltage produced when the protection device operates from a closed state to an opened state; and
transmitting, in response to the detected voltage, an indication that the protection device operated from a closed state to an opened state.

2. The method of claim 1, further comprising latching, in response to the detected voltage, the indication that the protection device operated from the closed state to the opened state.

3. The method of claim 1, wherein detecting the voltage across the protection device comprises detecting the voltage across the protection device comprising one of the following: a fuse and a circuit breaker.

4. The method of claim 1, wherein detecting the voltage across the protection device, the voltage produced when the protection device operates from the closed state to the opened state comprises detecting the voltage across the protection device, the voltage produced when the protection device operates from the closed state to the opened state due to an over current condition.

5. The method of claim 1, wherein detecting the voltage across the protection device comprises detecting the voltage comprising a momentary voltage.

6. The method of claim 5, wherein detecting the voltage comprising the momentary voltage comprises detecting the momentary voltage lasting less than or equal to 150 milliseconds.

7. The method of claim 1, wherein transmitting, in response to the detected voltage, the indication comprises transmitting, in response to the detected voltage, the indication comprising data identifying the protection device.

8. A system for detecting a protection device operation, the system comprising:
a first component configured to detect a voltage across a protection device, the voltage produced when the protection device operates from a closed state to an opened state; and
a transmitting component configured for transmitting, in response to the detected voltage, an indication that the protection device operated from a closed state to an opened state.

9. The system of claim 8, further comprising a second component configured to latch, in response to the detected voltage, the indication that the protection device operated from the closed state to the opened state.

10. The system of claim 9, wherein the first component is photo isolated from the second component.

11. The system of claim 8, wherein the protection device comprising one of the following: a fuse and a circuit breaker.

12. The system of claim 8, wherein first component configured to detect the voltage across the protection device, the voltage produced when the protection device operates from the closed state to the opened state comprises the first component configured to detect the voltage across the protection device, the voltage produced when the protection device operates from the closed state to the opened state due to an over current condition.

13. The system of claim 8, wherein the first component configured to detect the voltage across the protection device comprises the first component configured to detect the voltage comprising a momentary voltage.

14. The system of claim 13, wherein the momentary voltage lasting less than or equal to 150 milliseconds.

15. A system for detecting a protection device operation, the system comprising:
a memory storage for maintaining a database; and
a processing unit coupled to the memory storage, wherein the processing unit is operative to:
detect a voltage across a protection device, the voltage produced when the protection device operates from a closed state to an opened state; and
transmit, in response to the detected voltage, an indication that the protection device operated from a closed state to an opened state.

16. The system of claim 15, further comprising the processing unit operative to latch, in response to the detected voltage, the indication that the protection device operated from the closed state to the opened state.

17. The system of claim 15, wherein the processing unit operative to detect the voltage across the protection device comprises the processing unit operative to detect the voltage across the protection device comprising one of the following: a fuse and a circuit breaker.

18. The system of claim 15, wherein the processing unit operative to detect the voltage across the protection device, the voltage produced when the protection device operates from the closed state to the opened state comprises the processing unit operative to detect the voltage across the protection device, the voltage produced when the protection device operates from the closed state to the opened state due to an over current condition.

19. The system of claim 15, wherein the processing unit operative to detect the voltage across the protection device comprises the processing unit operative to detect the voltage comprising a momentary voltage.

20. The system of claim 19, wherein the momentary voltage lasting less than or equal to 150 milliseconds.
